(19) United States
(12) Patent Application Publication
(10) Pub. No.: US 2025/0321520 A1
(43) Pub. Date: Oct. 16, 2025

(54) FIXING DEVICE AND IMAGE FORMING APPARATUS

(71) Applicant: CANON KABUSHIKI KAISHA, Tokyo (JP)

(72) Inventors: AKIYOSHI SHINAGAWA, Saitama (JP); SUGURU TAKEUCHI, Chiba (JP); KENGO KOYAMA, Chiba (JP); YASUHARU TORATANI, Chiba (JP); AYANO SAITO, Chiba (JP); HIROSHI MIYAMOTO, Saitama (JP); SHIGERU TANAKA, Tokyo (JP); KIYONORI SOTOME, Ibaraki (JP); MASAKI SUDA, Ibaraki (JP)

(21) Appl. No.: 19/050,195

(22) Filed: Feb. 11, 2025

(30) Foreign Application Priority Data
Apr. 11, 2024 (JP) 2024-063985

(51) Int. Cl. G03G 15/20

(52) U.S. Cl. CPC G03G 15/2053; G03G 15/2039; G03G 15/2064; G03G 2215/2035

(57) ABSTRACT

Disclosed is a fixing device including: an endless belt member that is rotatably provided; a pressure member that abuts on the belt member to form a nip; and a heating member that is provided in contact with or not in contact with the belt member and is configured to heat the belt member; wherein when a length of the belt member that faces the heating member in a contact or non-contact manner in a rotation direction of the belt member is defined as a heating length Lh, and a length of the belt member that abuts on the pressure member in the rotation direction of the belt member is defined as a nip length Ln, the heating length Lh is set with respect to the nip length Ln to satisfy a relationship, −2.5*Ln+75≤Lh≤95 and 16≤Ln≤27.

### BACKGROUND OF THE INVENTION

### Field of the Invention

The present invention relates to a fixing device that heats an image formed on a recording material and an image forming apparatus.

### Description of the Related Art

In an image forming apparatus, a toner image is formed on a recording material, and a fixing device applies heat and pressure to the toner image to fix it onto the recording material.

As one of conventional fixing devices, a belt type fixing device is described in Patent Document 1. The fixing device described in Japanese Patent Application Laid-Open No. 2007-79036 includes a heating rotating body that heats an image on a recording material at a heating nip, an endless belt that cooperates with the heating rotating body to form the heating nip, and a pressure member that presses the belt against the heating rotating body at the heating nip. This fixing device nips and conveys a recording material bearing an unfixed toner image, and at the same time fixes the toner image onto the recording material with heat and pressure at the heating nip which is a contact portion between the belt and the rotating body.

### SUMMARY OF THE INVENTION

A fixing device includes:
an endless belt member that is stretched by a plurality of stretching members and is rotatably provided;
a pressure member that is provided to face the belt member, abuts on the belt member to form a nip, and is configured to cooperate with the belt member to nip and convey a recording material at the nip; and
a heating member that is provided in contact with or not in contact with the belt member and is configured to heat the belt member;
wherein when a length of the belt member that faces the heating member in a contact or non-contact manner in a rotation direction of the belt member is defined as a heating length Lh, and a length of the belt member that abuts on the pressure member in the rotation direction of the belt member is defined as a nip length Ln,
the heating length Lh is set with respect to the nip length Ln to satisfy a relationship,

$$- 2.5 * Ln + 75 \leq Lh \leq 95 and 16 \leq Ln \leq 27.$$

According to the present invention, it is possible to improve heating efficiency for a recording material when heating an image formed on the recording material.

Further features of the present invention will become apparent from the following description of exemplary embodiments with reference to the attached drawings.

### BRIEF DESCRIPTION OF THE DRAWINGS

FIG. 1 is a schematic diagram of an image forming apparatus.

FIG. 2 is a schematic diagram of a fixing device.

FIG. 3 is a schematic diagram illustrating a belt heating length and a fixing nip length of the fixing device.

FIG. 4 is a schematic diagram illustrating the belt heating length and the fixing nip length of a fixing device.

FIG. 5 is a schematic diagram illustrating the belt heating length and the fixing nip length of a fixing device.

FIG. 6 is a schematic diagram illustrating the belt heating length and the fixing nip length of a fixing device.

FIG. 7 is a graph showing a relationship between the fixing nip length and a belt surface temperature.

FIG. 8 is a graph showing a relationship between the belt heating length and the belt surface temperature.

FIG. 9 is a graph showing a relationship between the fixing nip length and the belt heating length.

FIG. 10 is a graph showing a relationship between the belt heating length and start-up time.

FIG. 11 is a graph showing a relationship between the fixing nip length and a driving torque.

FIG. 12 is a graph showing a range of the fixing nip length and the belt heating length.

### DESCRIPTION OF THE EMBODIMENTS

Hereinafter, an embodiment of an image forming apparatus according to the present invention will be exemplarily described in detail with reference to the drawings. In the following, an example in which the present invention is applied to an electrophotographic full-color image forming apparatus having a plurality of photosensitive drums will be described. However, the present invention is not limited to this example, and can also be applied to various types of image forming apparatuses, monochrome image forming apparatuses, and the like. In addition, dimensions, materials, shapes, and relative arrangements of components described in the following embodiment should be appropriately changed depending on a configuration and various conditions of an apparatus to which the present invention is applied, and the scope of the present invention is not intended to be limited to them.

### First Embodiment

### <Image Forming Apparatus>

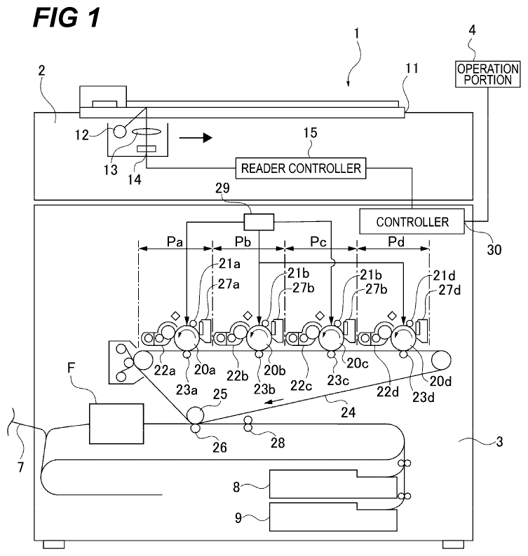

A schematic configuration of an image forming apparatus according to the present embodiment will be described with reference to FIG. 1. FIG. 1 is a schematic cross-sectional view illustrating a schematic configuration of the full-color image forming apparatus according to the present embodiment.

The image forming apparatus 1 includes an image reader 2 and an image forming apparatus main body 3. The image reader 2 reads an original placed on an original base plate glass 11. Light emitted from a light source 12 is reflected by the original, passes through an optical member 13 such as a lens, and forms an image on a CCD sensor 14. The light source 12, the optical member 13, and the CCD sensor 14 form an optical unit capable of scanning in an arrow direction. Such an optical unit converts the original into an electric signal data series for each line by scanning in the arrow direction. The image signal obtained by the CCD sensor 14 is sent from a reader controller 15 of the image reader 2 to the image forming apparatus main body 3, and is subjected to image processing corresponding to each image forming portion described later in a controller 30. The controller 30 also receives an external input as an image signal from an external host apparatus such as a print server. The controller 30 also receives an input from an operation portion 4 connected to the image forming apparatus main body 3 via a cable. Here, the operation portion 4 is an operation portion including a display that displays information, and is wire-connected to the image forming apparatus main body 3 via a cable. The configuration in which the operation portion 4 is wire-connected to the image forming apparatus main body 3 has been described as an example. However, the present invention is not limited to this configuration, and the operation portion 4 may be wirelessly connected.

The image forming apparatus main body 3 includes a plurality of image forming portions Pa, Pb, Pc, and Pd, and each image forming portion performs image formation based on the above-described image signal. That is, the image signal is converted into a laser beam subjected to pulse width modulation (PWM) control by the controller 30. In FIG. 1, a polygon scanner 29 as an exposure device scans the laser beam according to the image signal. Then, photosensitive drums 20a to 20d as image bearing members of the image forming portions Pa to Pd are irradiated with the laser beam. Note that the image forming portions Pa, Pb, Pc, and Pd correspond to yellow (Y), magenta (M), cyan (C), and black (Bk), respectively, and each forms an image of its corresponding color. Since the image forming portions Pa to Pd are substantially the same, the details of the image forming portion Pa will be described below, and the description of the other image forming portions Pb, Pc, and Pd will be omitted. In the image forming portion Pa, as will be described later, a toner image is formed on a surface of the photosensitive drum 20a based on the image signal.

A primary charger 21a charges the surface of the photosensitive drum 20a to a predetermined potential to prepare for electrostatic latent image formation. The laser beam from the polygon scanner 29 forms an electrostatic latent image on the surface of the photosensitive drum 20a charged to the predetermined potential. A development device 22a develops the electrostatic latent image on the photosensitive drum 20a to form a toner image. A transfer roller 23a discharges an intermediate transfer belt 24 from its back surface, applies a primary transfer bias having an opposite-polarity to that of the toner, and performs primary transfer of the toner image on the photosensitive drum 20a onto the intermediate transfer belt 24. The surface of the photosensitive drum 20a after the transfer is cleaned by a cleaner 27a.

The toner image on the intermediate transfer belt 24 is conveyed to the next image forming portion. Primary transfer of toner images of the respective colors formed in the image forming portions is sequentially performed in order of Y, M, C, and Bk, and an image of the four colors are formed on a surface of the intermediate transfer belt 24. A secondary transfer portion including a pair of secondary transfer rollers 25 and 26 performs secondary transfer of the toner image having passed through the image forming portion Pd onto a recording material by applying a secondary transfer electric field having an opposite-polarity to that of the toner image on the intermediate transfer belt 24. The recording material fed from a cassette 8 or 9 stands by in a registration portion 28. Then, the recording material is subjected to timing control to be aligned with the toner image on the intermediate transfer belt 24, and is conveyed from the registration portion 28 to the secondary transfer portion. Thereafter, the toner image on the recording material is fixed onto the recording material by a fixing device F as an image heating device. The recording material on which the image is fixed passes through the fixing device F and is then discharged to the outside of the apparatus. In the case of duplex printing, a toner image is transferred and fixed onto a first surface of a recording material. The recording material is turned over through a reversing portion provided inside the image forming apparatus after fixing, and is sent to the image forming portions again. Then, a toner image is transferred and fixed onto a second surface of the recording material. Thereafter, the recording material is discharged to the outside of the apparatus and is stacked on a sheet discharge tray 7.

### <Fixing Device>

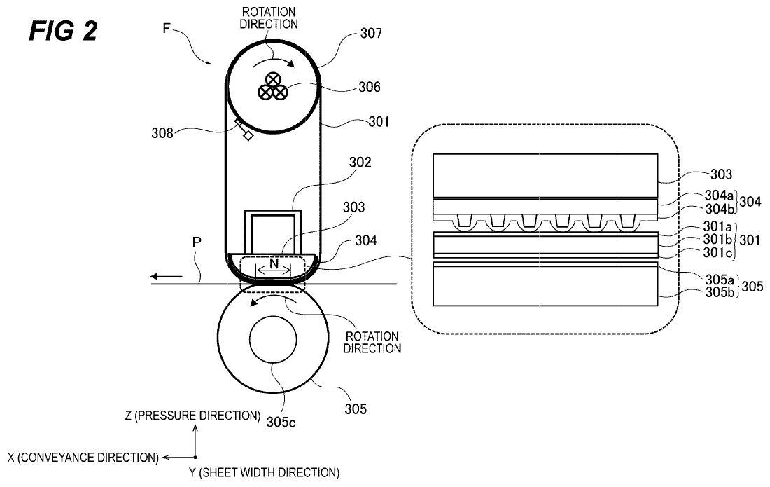

Next, a configuration of the fixing device F of a belt heating type according to the present embodiment will be described. FIG. 2 is a schematic diagram of an overall configuration of the fixing device. In FIG. 2, an X direction indicates a conveyance direction of a recording material P, a Y direction indicates a width direction orthogonal to the conveyance direction of a recording material P, and a Z direction indicates a pressure direction of a pressure roller 305. In FIG. 2, the Y direction is orthogonal to the X direction, and the Z direction is orthogonal to the X direction and the Y direction. An area surrounded by a dotted line in FIG. 2 represents an enlarged cross section of a portion of a fixing nip N in the fixing device F.

The fixing device F is an image heating device that heats an image formed on a recording material P. The fixing device F includes a fixing belt 301 as a belt member, a pressure roller 305 as a pressure member, a pressure pad 303 as a supporting member, and a heating roller 307 as a heating member. Furthermore, the fixing device F includes a stay 302 and a sliding member 304.

### (Fixing Belt)

The fixing belt 301 is thermally conductive and heat-resistant, and has a thin cylindrical shape. In the present embodiment, the fixing belt 301 has a three-layer structure including a base layer 301a, an elastic layer 301b formed on an outer periphery of the base layer 301a, and a toner parting layer 301c formed on an outer periphery of the elastic layer 301b. The base layer has a thickness of 80 μm and is made of polyimide (PI) resin. The elastic layer has a thickness of 300 μm and is made of silicone rubber. The toner parting layer has a thickness of 30 μm and is made of tetrafluoroethylene-perfluoroalkoxyethylene copolymer (PFA) resin as a fluororesin.

The fixing belt 301 is an endless belt member that is stretched by the pressure pad 303 and the heating roller 307 as a plurality of stretching members and is rotatably provided. The fixing belt 301 has an outer diameter of 100 mm.

### (Pressure Roller)

The pressure roller 305 is provided to face the fixing belt 301, and abuts on the fixing belt 301 to form a fixing nip N. The pressure roller 305 cooperates with the fixing belt 301 to nip and convey a recording material P at the fixing nip N.

The pressure roller 305 is a rotatable pressure member including a shaft (core metal layer) 305c, an elastic layer 305b formed on an outer periphery of the shaft 305c, and a toner parting layer 305a formed on an outer periphery of the elastic layer 305b. The shaft (core metal layer) 305c is a SUS member having a diameter of 72 mm. The elastic layer 305b is made of conductive silicone rubber having a thickness of 8 mm. The toner parting layer 305a has a thickness of 100 μm and is made of tetrafluoroethylene-perfluoroalkoxyethylene copolymer (PFA) resin as a fluororesin. The pressure roller 305, the shaft of which is supported by a frame (not illustrated) of the fixing device F, has one end portion to which a gear is fixed, and is connected to a drive source (not illustrated) via the gear to be rotationally driven.

At the fixing nip N formed between the fixing belt 301 and the pressure roller 305, a recording material P bearing a toner image is nipped and conveyed, and at the same time the toner image is heated. In this manner, the fixing device F fixes a toner image onto a recording material P while nipping and conveying the recording material P. Therefore, both a function of applying heat and pressure and a function of conveying a recording material P are required. The driving source (not illustrated) causes the pressure roller 305 to apply pressure to the pressure pad 303 via the fixing belt 301.

### (Pressure Pad)

The pressure pad 303 is a supporting member that supports the fixing belt 301 in contact with the fixing belt 301 at the fixing nip N. The pressure pad 303 is pressed by the pressure roller 305 with the fixing belt 301 sandwiched therebetween. The pressure pad 303 is made of liquid crystal polymer (LCP) resin.

The pressure pad 303 also serves as a stretching member that stretches the fixing belt 301 in contact with the fixing belt 301 at a position facing the pressure roller 305 via the fixing belt 301. That is, the pressure pad 303 is included in the plurality of stretching members that stretches the fixing belt 301.

The pressure pad 303 is covered by the sliding member 304. In other words, the sliding member 304 is interposed between the pressure pad 303 and the fixing belt 301.

The sliding member 304 of the present embodiment includes a base material layer 304a and a sliding layer 304b as a surface of the sliding member 304. It is sufficient that the base material layer 304a has sufficient heat resistance and strength. The base material layer 304a is desirably made of a metal material such as SUS, copper, or aluminum. In the present embodiment, SUS having a thickness of 1.3 mm is used. In the sliding member 304, an embossed portion is formed such that the distance between the pressure pad 303 and the fixing belt 301 is 1.4 [mm], to reduce a contact area with the fixing belt 301, thereby reducing sliding resistance. The sliding layer 304b can be provided with a material (fluorine coating, PTFE, PFA, etc.) in order to achieve low friction. In the present embodiment, the base material layer 304a is coated with polytetrafluoroethylene (PTFE) having a thickness of 20 μm as the sliding layer 304b. Here, a lubricant is further applied to the inner surface of the fixing belt 301 (surface on the sliding member 304 side), allowing the fixing belt 301 to slide smoothly with respect to the sliding member 304. Silicone oil is used as the lubricant described above.

In order to supplement the strength of the pressure pad 303, the stay 302 is used to support the pressure pad 303.

In this manner, the pressure pad 303 is in contact with the fixing belt 301 via the sliding member 304. This allows the fixing belt 301 to smoothly rotate, since the sliding member 304 reduces the sliding resistance.

In the present embodiment, the sliding member 304 has a configuration in which the sliding layer 304b is provided on the base material layer 304a. However, the sliding member 304 is not limited to this configuration, and may have a configuration in which an adhesive layer is provided between the base material layer 304a and the sliding layer 304b. Using an adhesive layer in the sliding member 304 makes it possible to exhibit good adhesive strength between the base material layer 304a and the sliding layer 304b when the base material layer 304a is made of a metal material such as SUS, copper, or aluminum.

The sliding member 304 of the present embodiment is configured to cover the pressure pad 303 whether inside or outside the fixing nip N. Although not illustrated, it is sufficient that a part of the fixing nip N is covered by the sliding member 304. That is, the sliding member 304 may be disposed only in the fixing nip N.

In the present embodiment, the embossed portion of the sliding member 304 is formed over the entire sliding member 304. Although not illustrated herein, it is sufficient that a part of the fixing nip N is covered by the embossed portion. That is, the embossed portion of the sliding member 304 may be disposed only in the fixing nip N.

In the present embodiment, a configuration in which the sliding member 304 is fixed to the stay 302 is adopted (not illustrated). Although not illustrated herein, the sliding member 304 may be integrated with the pressure pad 303. Alternatively, the sliding member 304 may be partially fixed to the stay 302 or the pressure pad 303. For example, both end portions of the sliding member 304 in the Y direction (width direction of a recording material) may be fixed to the pressure pad 303 with screws.

### (Heating Roller)

The heating roller 307 is a heating member that heats the fixing belt 301 in contact with the fixing belt 301 at a position different from the fixing nip N.

The heating roller 307 also serves as a stretching member that stretches the fixing belt 301 in contact with the fixing belt 301 at a position different from the pressure pad 303. That is, the heating roller 307 is included, along with the pressure pad 303, in the plurality of stretching members that stretches the fixing belt 301.

The heating roller 307 is a stainless pipe having a thickness of 2.1 mm. The heating roller 307 is a rotating member that rotates in contact with the fixing belt 301. A halogen heater 306 as a heat source is disposed inside the heating roller 307 and can generate heat to a predetermined temperature. The halogen heater 306 is controlled to the predetermined temperature according to a temperature detected by a temperature detection member 308 abutting on the outer surface of the heating roller 307. The fixing belt 301 is heated by the heating roller 307.

Although the configuration in which the temperature detection member 308 abuts on the heating roller 307 to detect the temperature of the heating roller 307 has been described as an example, the present invention is not limited to this configuration. For example, the temperature detection member 308 may abut on the fixing belt 301 to detect the temperature of the fixing belt 301.

The heating roller 307 is a steering roller that has a turning center at one end thereof or in the vicinity of the middle in the longitudinal direction (width direction of a recording material) and turns with respect to the fixing belt 301. The heating roller 307 turns with respect to the fixing belt 301 to generate a tension difference between front and back, which are one side and the other side in the width direction orthogonal to a rotation direction of the fixing belt 301, thereby controlling a position of the fixing belt 301 in the width direction. In addition, the heating roller 307 is biased by a spring supported by the frame (not illustrated) of the fixing device F, and is also a tension roller that applies a predetermined tension to the fixing belt 301.

### <Definition of Belt Heating Length and Fixing Nip Length>

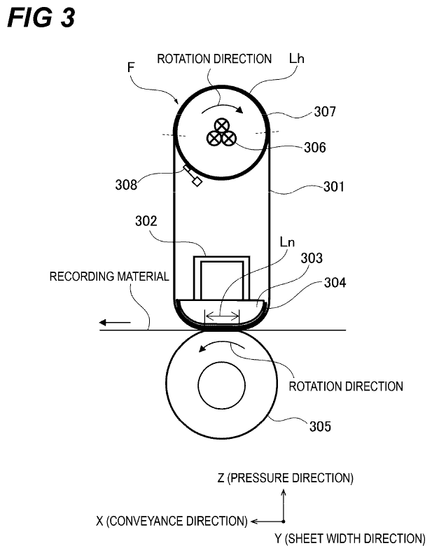

Here, a belt heating length Lh and a fixing nip length Ln will be described using fixing devices F illustrated in FIGS. 3 to 6 as examples. FIGS. 3 to 6 are schematic diagrams illustrating a belt heating length Lh and a fixing nip length Ln of a fixing device F.

As described above, the pressure roller 305 abuts on the fixing belt 301 to form the fixing nip N. The length where the pressure roller 305 abuts on the fixing belt 301 in the rotation direction of the fixing belt 301 is defined as a fixing nip length Ln. That is, the fixing nip length Ln is the length of the fixing nip N in the rotation direction of the fixing belt 301.

The heating roller 307 that heats the fixing belt 301 is provided in contact with or not in contact with the fixing belt 301. The length of the fixing belt 301 that faces the heating roller 307 in a contact or non-contact manner in the rotation direction of the fixing belt 301 is defined as a belt heating length Lh.

In the fixing device F illustrated in FIG. 3, the heating roller 307, which is provided in contact with the fixing belt 301 at a position different from the pressure pad 303 and stretches the fixing belt 301, also serves as a stretching member that stretches the fixing belt 301. In this case, the length where the heating roller 307 is in contact with the fixing belt 301 in the rotation direction of the fixing belt 301 is defined as the belt heating length Lh.

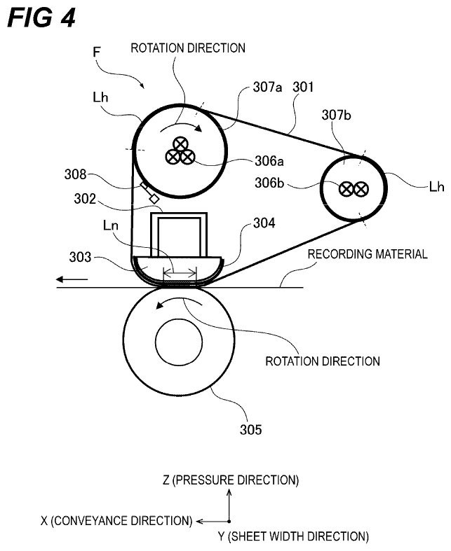

The fixing device F illustrated in FIG. 4 includes a plurality of heating rollers 307a and 307b. That is, a heating member that heats the fixing belt 301 includes the plurality of heating rollers 307a and 307b.

The heating rollers 307a and 307b are configured similarly to the above-described heating roller 307. The first heating roller 307a and the second heating roller 307b as rotating members include halogen heaters 306a and 306b as heat sources therein, respectively.

The first heating roller 307a also serves as a first stretching member that is provided in contact with the fixing belt 301 at a position different from the pressure pad 303 and stretches the fixing belt 301. The second heating roller 307b also serves as a second stretching member that is provided in contact with the fixing belt 301 at a position between the first heating roller 307a and the pressure pad 303 and stretches the fixing belt 301.

In the fixing device F illustrated in FIG. 4, the first heating roller 307a and the second heating roller 307b are in contact with the inner peripheral surface of the fixing belt 301.

In the case of the fixing device F illustrated in FIG. 4, the length of the fixing belt 301 that is in contact with the first heating roller 307a and the second heating roller 307b in the rotation direction of the fixing belt 301 is defined as the belt heating length Lh.

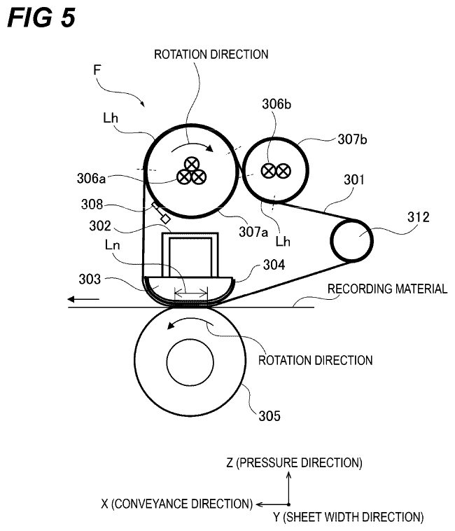

The fixing device F illustrated in FIG. 5 also includes a plurality of heating rollers 307a and 307b like the fixing device F illustrated in FIG. 4. In addition to the plurality of heating rollers 307a and 307b, the fixing device F further includes, as a plurality of stretching members, a stretching roller 312 that is provided in contact with the fixing belt 301 at a position between the second heating roller 307b and the pressure pad 303 and stretches the fixing belt 301. In the fixing device F illustrated in FIG. 5, one of the first heating roller 307a and the second heating roller 307b is in contact with the inner peripheral surface of the fixing belt 301 and the other is in contact with the outer peripheral surface of the fixing belt 301.

Thus, also in the case of the fixing device F illustrated in FIG. 5, as in the case of the fixing device F illustrated in FIG. 4, the length of the fixing belt 301 that is in contact with the first heating roller 307a and the second heating roller 307b in the rotation direction of the fixing belt 301 is defined as the belt heating length Lh.

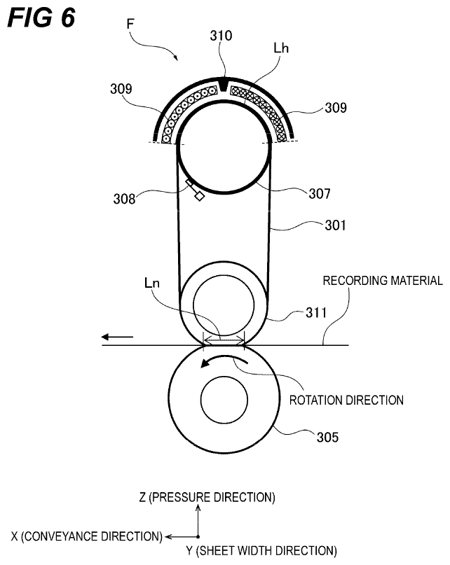

In the fixing device F illustrated in FIG. 6, the heating roller 307, which is provided in contact with the fixing belt 301 at a position different from the pressure pad 303 and stretches the fixing belt 301, is a stretching member that stretches the fixing belt 301. In the fixing device F illustrated in FIG. 6, a heating member of an induction heating type is provided separately from this stretching member.

Specifically, the fixing device F includes an excitation coil 309 and a magnetic core 310 as the heating member. The excitation coil 309 and the magnetic core 310 are provided not in contact with the fixing belt 301 at a position facing the heating roller 307 via the fixing belt 301. In this case, the length of the fixing belt 301 that faces the longer one of the excitation coil 309 and the magnetic core 310 in the rotation direction of the fixing belt 301 is defined as the belt heating length Lh.

In addition, the fixing device F illustrated in FIG. 6 includes a fixing roller 311 instead of the pressure pad 303. The fixing roller 311 is a supporting member that supports the fixing belt 301 in contact with the fixing belt 301 at the fixing nip N, and is a rotatable rotating member.

Although the fixing nip length Ln is defined as the length of contact between the fixing belt 301 and the pressure roller 305 immediately before sheet passing of a recording material P, the fixing nip length Ln may be defined as the length of contact between the fixing belt 301 and a recording material P at the time of image formation. At this time, as a definition of contact, an abutting pressure (contact pressure) between the fixing belt 301 and the pressure roller 305 is desirably 0.05 [MPa] or more at normal temperature. As an example of pressure distribution measurement at the fixing nip N, a tactile sensor (surface pressure distribution measurement system, I-SCAN) manufactured by Nitta Corporation can be used for the measurement.

The supporting member that abuts on the fixing belt 301 from the inner surface at the position facing the pressure roller 305 is not limited to the pressure pad 303, and may be the fixing roller 311 as a rotating member as illustrated in FIG. 6. Furthermore, a heating source may be installed inside the fixing roller 311 illustrated in FIG. 6 or inside the stay 302 illustrated in FIG. 2. In other words, the supporting member may also serve as a heating member that heats the fixing belt. In a case where a heating source is installed in this manner and heats the fixing roller 311 or the pressure pad 303 to a higher temperature than the temperature of the fixing belt 301, the fixing nip N can be considered to contribute to the belt heating length Lh as well as the fixing nip length Ln. In this case, the length of the fixing belt 301 that is in contact with the heating roller 307 and the pressure pad 303 in the rotation direction of the fixing belt 301 is defined as the belt heating length Lh.

For example, since the heating roller 307 swings around the turning center, the belt heating length Lh and the fixing nip length Ln may both change over time. In this case, the belt heating length Lh and the fixing nip length Ln in the present embodiment are defined when the heating roller 307 is positioned near the center with respect to the turning movement.

The configuration of the fixing devices F illustrated in FIGS. 4 and 5 in which the heating roller having the heat source therein is used as a heating member and the heating member is in contact with the fixing belt has been described as an example. However, the present invention is not limited to this configuration. For example, also in the fixing devices F illustrated in FIGS. 4 and 5, as in the configuration illustrated in FIG. 6, a heating member may be provided at positions facing the heating rollers 307a and 307b via the fixing belt 301. That is, the heating member may be provided not in contact with the fixing belt.

### <Condition for Fixation>

In order to fix a toner image formed on a recording material P, it is necessary to raise the temperature of an interface between the recording material and the toner immediately after coming out of the fixing nip N to a temperature at which the toner is completely melted or higher. For this reason, it is necessary to set the temperature of the fixing belt 301 immediately before the fixing nip N to a certain level or higher.

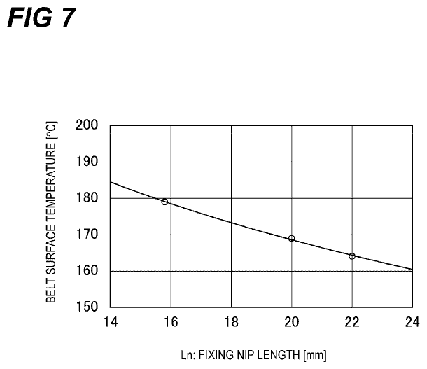

In the present embodiment, the fixing belt 301 is driven at a constant speed of 350 [mm/sec] to achieve sheet passing of an A4-sized recording material P at a rate of 90 sheets per minute in transverse feed. FIG. 7 is a graph showing a relationship between the fixing nip length Ln [mm] and a minimum surface temperature [° C.] of the fixing belt 301 at which the toner image can be fixed on a coated sheet having a basis weight of 250 [gsm] when the fixing nip length Ln is changed. According to FIG. 7, for example, that if the fixing nip length Ln is 20 [mm], the surface temperature of the fixing belt 301 just before the fixing nip Nis 168 [C] or more and the toner image can be fixed. When the fixing nip length Ln increases, the surface temperature of the fixing belt 301 immediately before the fixing nip N can be heated to a lower temperature that allows the toner to be completely melted because the time for heating the toner increases accordingly.

In addition, in order to perform continuous fixation on a next recording material P, it is necessary to restore the surface temperature of the fixing belt 301 that has been lowered by a previous recording material P passing through the fixing nip N. At this time, if the temperature of the heating roller 307 could be set sufficiently high, even the short belt heating length Lh could restore the surface temperature of the fixing belt 301 to a required temperature. However, the temperature of the heating roller 307 is limited and is not raised above a predetermined level. For example, when the temperature of the heating roller 307 is controlled with the temperature detection member 308 of a contact type, the heating roller 307 can only be heated up to a guaranteed operating temperature of the temperature detection member 308. Therefore, to set the surface temperature of the fixing belt 301 to a high level, the belt heating length Lh plays a significant role as well as the heating temperature of the heating roller 307.

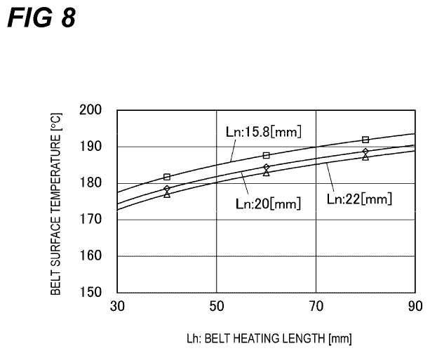

In the present embodiment, the temperature detection member 308 having a guaranteed operating temperature of 224 [C] is used. FIG. 8 shows a result of measuring the surface temperature [° C.] of the fixing belt 301 immediately before the fixing nip N during sheet passing of a coated sheet having a basis weight of 250 [gsm] at a rate of 90 sheets per minute with the heating roller 307 heated at a maximum temperature of 224 [° C.]. According to the result of FIG. 8, it can be seen that when the fixing nip length Ln is 20 [mm] and the belt heating length Lh is 60 [mm], the surface temperature of the fixing belt 301 can be maintained at 184 [° C.]. As the belt heating length Lh increases, the surface temperature [° C.] of the fixing belt 301 becomes higher.

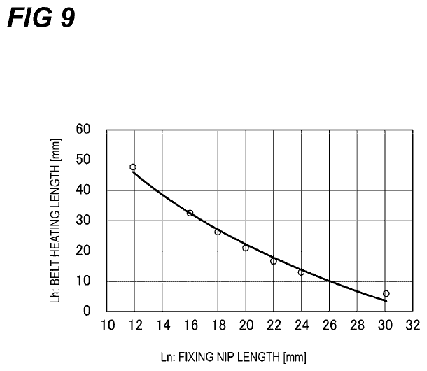

FIG. 9 shows conditions that simultaneously satisfy conditions of the surface temperature [° C.] of the fixing belt 301 for fixation according to the fixing nip length Ln (FIG. 7) and conditions of the belt heating length Lh for maintaining the surface temperature [° C.] of the fixing belt 301 at the temperature for fixation (FIG. 8). FIG. 9 is a graph showing a relationship between the fixing nip length Ln and the belt heating length Lh. The solid line in FIG. 9 is a boundary of the belt heating length Lh at which the surface temperature of the fixing belt 301 becomes the fixation temperature (minimum temperature at which the toner can be melted) when the fixing nip length Ln is changed with the heating roller 307 maintained at the maximum temperature of 224 [° C.].

However, even when the conditions illustrated in FIG. 9 are simultaneously satisfied, that is, even when fixation is possible, significant deterioration in gloss of an image surface may occur. For example, when the fixing nip length Ln is set to 14 [mm] and the belt heating length Lh is set to 61 [mm] and the surface temperature of the fixing belt 301 is set to 185 [° C.], the toner itself is melted and fixed onto a recording material P. However, crater-like unevenness where air bubbles appear to have escaped occurs on a toner layer surface, resulting in a significant reduction in the gloss of an image. This is presumed to be a phenomenon in which an air layer, which is originally in a gap between spherical toner particles and should have escaped from a toner surface layer in the process of melting and smoothly flattening a group of the spherical toner particles at the fixing nip N, escapes after exiting the fixing nip N, thereby roughening the image surface. Thus, in order to avoid this phenomenon, the fixing nip length Ln is desirably 16 mm or more. When the fixing nip length Ln was set to 16 [mm], the significant reduction in the gloss of an image did not occur.

From the above, it has been found that, in order for the fixing device F to fix the toner, the belt heating length Lh needs to be in the range above the solid line in FIG. 9, and the fixing nip length Ln needs to be 16 mm or more.

That is, the fixing nip length Ln is set to satisfy Ln≥16 (range in which the gloss reduction of the image surface does not occur).

### <Start-up Time>

Next, start-up time of the fixing device F will be considered. The start-up time is the time it takes for the fixing belt 301 to be heated from a low temperature (for example, in a power OFF state or a sleep state) to an image formation temperature. The start-up time is substantially determined by an amount of power that can be used for the heating source of the fixing device F and the sum of the heat capacities of the fixing belt 301 and all the members in contact with the fixing belt 301 at the time of start-up. In the present embodiment, the low temperature is assumed to be a room temperature of 23 [° C.] that is a general installation environment of the image forming apparatus, and the image formation temperature is assumed to be 155 [C] at which printing can be performed on a sheet having a basis weight of about 100 [gsm] that is a general recording material, and thus the time for heating from 23 [C] to 155 [C] is used as the exemplary start-up time. In addition, maximum power to the fixing device F is assumed to be 2500 [W] that is obtained by subtracting power consumed by the apparatus except the fixing device F (approximately 500 [W]) from maximum power that can be supplied from a general outlet rated at 200 [V] and 15 [A].

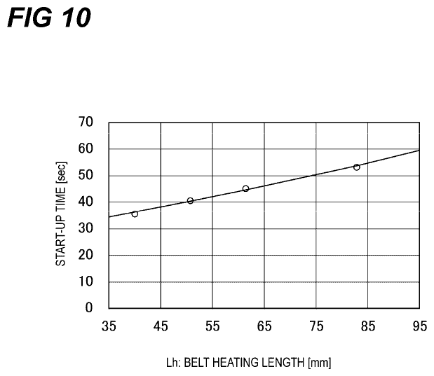

FIG. 10 shows a relationship between the start-up time [sec] and the belt heating length Lh under these conditions. The belt heating length Lh is plotted on the horizontal axis in FIG. 10 because it is necessary to increase the diameter of the heating roller 307 abutting on the fixing belt 301 and the circumferential length of the fixing belt 301 in proportion to the belt heating length Lh. Meanwhile, the pressure roller 305 is separated from the fixing belt 301 at the time of start-up, so that an increase in the fixing nip length Ln and an associated increase in the heat capacity of the pressure roller 305 do not substantially affect the start-up time.

In the present embodiment, a target of the start-up time is set to 60 [sec]. 60 [sec] is maximum recovery time for a multifunction machine that can perform printing at a rate of 89 sheets per minute or more according to the certification criteria for the International ENERGY STAR program. The result shown in FIG. 10 indicates the start-up time [sec] in a case where the belt heating length Lh is increased by increasing only the diameter by a certain factor while maintaining the thicknesses of the heating roller 307 and the fixing belt 301.

As an example, when the diameter of the heating roller 307 was set to 45 [mm], the belt heating length Lh was 51 [mm] and the start-up time was 41 [sec]. When the diameter of the heating roller 307 was set to 75 [mm], the belt heating length Lh was 83 [mm] and the start-up time was 54 [sec].

As described above, an increase in the belt heating length Lh increases the heat capacity and the start-up time. Therefore, it has been found that, in order for the start-up time to be less than 60 [sec], the belt heating length Lh needs to be less than 96 [mm].

That is, the belt heating length Lh is set to satisfy Lh≤95 (range in which the start-up time is 60 seconds or less in FIG. 10).

### <Stable Driving>

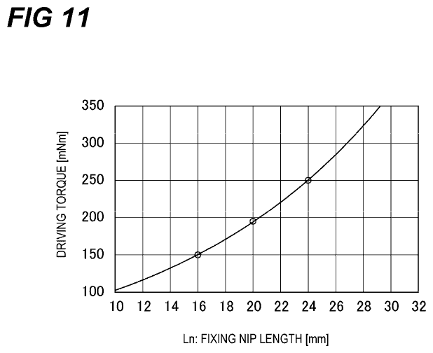

Meanwhile, in the present embodiment, it is known that an excessive increase in the fixing nip length Ln results in unstable driving of the fixing belt 301. This is because the driving torque of the fixing belt 301 increases in proportion to the increase in the fixing nip length Ln due to the sliding member 304 that forms the fixing nip N sliding on the inner surface of the fixing belt 301. FIG. 11 is a graph showing a relationship between the fixing nip length Ln [mm] and the driving torque [mNm] when the fixing nip length Ln is changed. In the present embodiment, it has been found that the fixing nip length Ln is not allowed to exceed 27.3 [mm] because the fixing belt 301 operates unstably at 350 [mm/sec] when the driving torque exceeds 310 [mNm].

That is, the fixing nip length Ln is set to satisfy Ln≤27 (range in which the driving torque is 310 [mNm] or less in FIG. 11).

As described above, it has been found that the fixing nip length Ln needs to be 16 [mm] or more, and the fixing nip length Ln is not allowed to exceed 27.3 [mm]. In addition, it has been found that, in order for the fixing device F to fix the toner, the belt heating length Lh needs to be in the range above the solid line in FIG. 9.

According to the solid line in FIG. 9, when the fixing nip length Ln is 16 [mm], the belt heating length Lh is 35 [mm]. When the fixing nip length Ln is 27 [mm], the belt heating length Lh is 7.5 [mm].

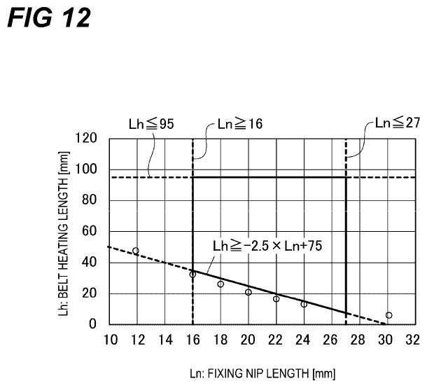

That is, the belt heating length Lh [mm] is set in a range above a straight line connecting the point (16, 35) and the point (27, 7.5) illustrated in FIG. 12 to satisfy Lh≥−2.5*Ln+75 (range defined by the straight line above the curve in FIG. 9).

In summary, a relationship between the fixing nip length Ln and the belt heating length Lh to be satisfied by the fixing device F is as follows:

Lh≥−2.5*Ln+75 (range defined by the straight line above the curve in FIG. 9);
Ln≥16 (range in which the gloss reduction of the image surface does not occur);
Lh≤95 (range in which the start-up time is 60 [sec] or less in FIG. 10);
Ln≤27 (range in which the driving torque is 310 [mNm] or less in FIG. 11).

FIG. 12 shows a range that satisfies the above conditions, and the fixing device F proposed in the present embodiment is inside the region surrounded by straight lines.

As described above, according to the present embodiment, the belt heating length Lh is set with respect to the fixing nip length Ln to satisfy the relationship, −2.5*Ln+75≤Lh≤95 and 16≤Ln≤27. This makes it possible to improve heating efficiency for a recording material when heating an image formed on the recording material. It is possible to both shorten printing time and shorten the start-up time while suppressing an increase in size of the apparatus.

In addition, the fixing nip length Ln and the belt heating length Lh are set to satisfy the relationship while the temperature is in a range up to the maximum temperature of the guaranteed operating temperature of the temperature detection member 308. This makes it possible to improve heating efficiency for a recording material when heating an image formed on the recording material.

Note that, there has been described herein, as an example of an image heating device that heats a toner image on a recording material, the fixing device that is mounted on an image forming apparatus such as a printer or a copying machine and fixes a toner image on a recording material to the recording material. However, the present invention is not limited to such a fixing device, and can also be applied to, for example, an image heating device such as a glossing device that improves gloss of an image formed on a recording material. The present invention can also be applied to an image heating device that is not mounted on an image forming apparatus.

The image forming apparatus including one fixing device has been described herein as an example. However, the present invention is not limited to this example, and is also effective in an image forming apparatus including a plurality of fixing devices.

The copying machine has been described herein as an example of an image forming apparatus. However, the present invention is not limited to this example, and may be applied to, for example, another image forming apparatus such as a printer or a facsimile machine, or another image forming apparatus such as a multifunction machine that combines the functions thereof. Furthermore, there has been described, as an example, the image forming apparatus in which an intermediate transfer member is used, toner images of respective colors are transferred onto the intermediate transfer member in a sequentially superimposed manner, and the toner images borne on the intermediate transfer member are collectively transferred onto a recording material. However, the present invention is not limited to this example. The present invention may be applied to an image forming apparatus in which a recording material carrier is used and toner images of respective colors are transferred onto a recording material carried by the recording material carrier in a sequentially superimposed manner. Similar effects can be obtained by applying the present invention to these image forming apparatuses.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-063985, filed Apr. 11, 2024, which is hereby incorporated by reference herein in its entirety.

What is claimed is:

1. A fixing device comprising:
an endless belt member that is stretched by a plurality of stretching members and is rotatably provided;
a pressure member that is provided to face the belt member, abuts on the belt member to form a nip, and is configured to cooperate with the belt member to nip and convey a recording material at the nip; and
a heating member that is provided in contact with or not in contact with the belt member and is configured to heat the belt member;
wherein when a length of the belt member that faces the heating member in a contact or non-contact manner in a rotation direction of the belt member is defined as a heating length Lh, and a length of the belt member that abuts on the pressure member in the rotation direction of the belt member is defined as a nip length Ln,
the heating length Lh is set with respect to the nip length Ln to satisfy a relationship,
$$- 2.5 * Ln + 75 \leq Lh \leq 95 and 16 \leq Ln \leq 27.$$

2. The fixing device according to claim 1,
wherein an abutting pressure between the belt member and the pressure member is 0.05 [MPa] or more.

3. The fixing device according to claim 1,
wherein the plurality of stretching members includes a supporting member configured to support the belt member in contact with the belt member at a position facing the pressure member via the belt member.

4. The fixing device according to claim 3,
wherein the plurality of stretching members includes a stretching member that is provided in contact with the belt member at a position different from the supporting member and is configured to stretch the belt member,
the heating member also serves as the stretching member, and
a length of the belt member that is in contact with the heating member in the rotation direction of the belt member is defined as the heating length Lh.

5. The fixing device according to claim 3,
wherein the plurality of stretching members includes a stretching member that is provided in contact with the belt member at a position different from the supporting member and is configured to stretch the belt member,
the heating member is provided not in contact with the belt member at a position facing the stretching member via the belt member, and
a length of the belt member that faces the heating member in a non-contact manner in the rotation direction of the belt member is defined as the heating length Lh.

6. The fixing device according to claim 3,
wherein the plurality of stretching members includes a first stretching member that is provided in contact with the belt member at a position different from the supporting member and is configured to stretch the belt member, and a second stretching member that is provided in contact with the belt member at a position between the first stretching member and the supporting member and is configured to stretch the belt member
the heating member includes a first heating member that also serves as the first stretching member, and a second heating member that also serves as the second stretching member, and
a length of the belt member that is in contact with the first heating member and the second heating member in the rotation direction of the belt member is defined as the heating length Lh.

7. The fixing device according to claim 6,
wherein the first heating member and the second heating member are in contact with an inner peripheral surface of the belt member.

8. The fixing device according to claim 6,
wherein one of the first heating member and the second heating member is in contact with an inner peripheral surface of the belt member and another is in contact with an outer peripheral surface of the belt member.

9. The fixing device according to claim 3,
wherein the supporting member also serves as the heating member.

10. The fixing device according to claim 1, further comprising:
a temperature detection member configured to detect a temperature of the heating member or the belt member,
wherein the nip length Ln and the heating length Lh are set to satisfy the relationship while the temperature is in a range up to a maximum temperature of a guaranteed operating temperature of the temperature detection member.

11. An image forming apparatus comprising: an image forming portion configured to form an image on a recording material; and the fixing device according to claim 1.

12. The image forming apparatus according to claim 11,
wherein an abutting pressure between the belt member and the pressure member is 0.05 [MPa] or more.

13. The image forming apparatus according to claim 11,
wherein the plurality of stretching members includes a supporting member configured to support the belt member in contact with the belt member at a position facing the pressure member via the belt member.

14. The image forming apparatus according to claim 13,
wherein the plurality of stretching members includes a stretching member that is provided in contact with the belt member at a position different from the supporting member and is configured to stretch the belt member,
the heating member also serves as the stretching member, and
a length of the belt member that is in contact with the heating member in the rotation direction of the belt member is defined as the heating length Lh.

15. The image forming apparatus according to claim 13,
wherein the plurality of stretching members includes a stretching member that is provided in contact with the belt member at a position different from the supporting member and is configured to stretch the belt member,
the heating member is provided not in contact with the belt member at a position facing the stretching member via the belt member, and
a length of the belt member that faces the heating member in a non-contact manner in the rotation direction of the belt member is defined as the heating length Lh.

16. The image forming apparatus according to claim 13,
wherein the plurality of stretching members includes a first stretching member that is provided in contact with the belt member at a position different from the supporting member and is configured to stretch the belt member, and a second stretching member that is provided in contact with the belt member at a position between the first stretching member and the supporting member and is configured to stretch the belt member
the heating member includes a first heating member that also serves as the first stretching member, and a second heating member that also serves as the second stretching member, and
a length of the belt member that is in contact with the first heating member and the second heating member in the rotation direction of the belt member is defined as the heating length Lh.

17. The image forming apparatus according to claim 16,
wherein the first heating member and the second heating member are in contact with an inner peripheral surface of the belt member.

18. The image forming apparatus according to claim 16,
wherein one of the first heating member and the second heating member is in contact with an inner peripheral surface of the belt member and another is in contact with an outer peripheral surface of the belt member.

19. The image forming apparatus according to claim 13,
wherein the supporting member also serves as the heating member.

20. The image forming apparatus according to claim 11, further comprising:
a temperature detection member configured to detect a temperature of the heating member or the belt member,
wherein the nip length Ln and the heating length Lh are set to satisfy the relationship while the temperature is in a range up to a maximum temperature of a guaranteed operating temperature of the temperature detection member.
